(19) United States
(12) Patent Application Publication
(10) Pub. No.: US 2020/0007409 A1
(43) Pub. Date: Jan. 2, 2020

(54) INTELLIGENT INTERNET OF EVERYTHING (IoE) EDGE COMPUTIING SYSTEM FOR HIGH RELIABLE INTERNET OF THINGS (IoT) SERVICE

(71) Applicant: ELECTRONICS AND TELECOMMUNICATIONS RESEARCH INSTITUTE, Daejeon (KR)

(72) Inventors: Kwi Hoon Kim, Daejeon (KR); Wan Seon Lim, Daejeon (KR); Yong Geun Hong, Daejeon (KR)

(21) Appl. No.: 16/456,518

(22) Filed: Jun. 28, 2019

(30) Foreign Application Priority Data
Jun. 29, 2018 (KR) 10-2018-0075842
Jun. 14, 2019 (KR) 10-2019-0070365

(51) Int. Cl. H04L 12/24; G06N 20/00; G06F 16/25; H04L 12/26

(52) U.S. Cl. CPC H04L 41/16; G06N 20/00; H04L 43/062; H04L 43/04; H04L 41/147; G06F 16/258

(57) ABSTRACT

An intelligent Internet of everything (IoE) edge computing system for a high reliable Internet of thins (IoT) service is provided. The intelligent IoE edge computing system for high reliable IoT services according to the present invention provides a modularized intelligent IoT framework for various applications and has a technical feature in that intelligent traffic analysis and prediction is performed.

### CROSS-REFERENCE TO RELATED APPLICATION

This application claims priority to and the benefit of Korean Patent Application No. 10-2018-0075842, filed on Jun. 29, 2018, and Korean Patent Application No. 10-2019-0070365, filed on Jun. 14, 2019, the disclosure of which is incorporated herein by reference in its entirety.

### BACKGROUND

### 1. Field of the Invention

The present invention relates to an intelligent Internet of Everything (IoE) edge computing system for a highly reliable Internet of things (IoT) service.

### 2. Discussion of Related Art

The Internet of things (IoT) environment has a problem in that it is an environment restricted by a device itself and a networking technology.

According to the related art, various technologies that provide connectivity in an IoT environment are proposed, but many IoT platforms developed in various IoT service fields along with a variety of edge/fog computing technologies coexist. Hence, an integrated IoT platform is not currently provided.

### SUMMARY OF THE INVENTION

The present invention proposes an autonomous configurable intelligent Internet of things (IoT) information framework and network control technologies for an IoT service, proposes a modularized intelligent IoT information framework applicable to various applications, and provides an intelligent Internet of everything (IoE) edge computing system capable of traffic analysis and prediction.

The present invention provides an autonomous configurable intelligent IoT information framework, edge node-based time series data prediction and decision technology, and services (e.g., smart IoT construction monitoring) based on the framework and technology.

According to one embodiment, unlike the related art in which edge computing has to be passively configured in accordance with service provider requirements, edge computing is autonomously configured by receiving service provider's requirements through words or a photograph.

In addition, a minimum cost is automatically predicted through rule-based, machine learning (ML)-based, and deep learning (DL)-based fusion prediction and traffic is controlled based on a policy by applying prediction and decision in a hybrid manner.

Examples of a policy include traffic minimization, cost minimization (flat rate pricing and usage-based pricing), quality of service (QoS) control according to user grade, exact alarm detection, and the like.

According to one embodiment of the present invention, a prediction and decision algorithm is automatically selected in accordance with service requirements.

In addition, according to one embodiment of the present invention, it is possible to apply to not only a smart construction service, but also various other services, and a video traffic control service for uplink traffic may be provided as a smart construction service.

An intelligent virtual reality (VR) cache may provide a service in which an image of an area frequently viewed by a user is transmitted in high definition and the image of the rest is transmitted in low definition through space-based video traffic control and image recognition.

For a VR video, people are highly likely to view a specific position, and for example, in the case of a martial art competition, players are mainly viewed.

For a smart transportation service, mobility control and QoS control may be performed by targeting an autonomous driving vehicle.

For a valuable transmission control service, provision of seamless video service is possible.

For a personal broadcasting uplink service, uplink traffic control optimized to grades of multiple users is possible.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a configuration of an autonomous configurable intelligent Internet of things (IoT) information framework according to one embodiment of the present invention;

FIG. 2 is a block diagram illustrating an intelligent IoT edge computing system according to one embodiment of the present invention;

FIG. 3 is a diagram illustrating a functional configuration of an intelligent IoT edge computing system according to one embodiment of the present invention;

FIG. 4 is a diagram illustrating reference points of an intelligent IoT edge computing system according to one embodiment of the present invention;

FIG. 5 illustrates a message format of a reference point according to one embodiment of the present invention;

FIG. 6A through FIG. 6D are diagrams illustrating message specifications of a reference point according to one embodiment of the present invention;

FIG. 7 is a flowchart illustrating autonomous initialization processing according to one embodiment of the present invention;

FIG. 8 is a flowchart illustrating intelligent data processing according to one embodiment of the present invention;

FIG. 9 is a flowchart illustrating intelligent data processing for terminal control according to one embodiment of the present invention;

FIG. 10 is a flowchart illustrating machine learning (ML) model update processing according to one embodiment of the present invention;

FIG. 11 is a diagram illustrating a configuration for edge node-based time series data prediction and decision according to one embodiment of the present invention;

FIG. 12 is a diagram illustrating procedures for edge node-based time series data prediction and decision according to one embodiment of the present invention;

FIGS. 13A and 13B illustrate decision algorithms according to one embodiment of the present invention;

FIG. 14 is a diagram illustrating a configuration of training and serving for edge node-based time series data prediction and decision according to one embodiment of the present invention;

FIG. 15 is a flowchart illustrating training and serving for edge node-based time series data prediction and decision according to one embodiment of the present invention;

FIGS. 16 and 17 are diagrams illustrating a configuration of smart IoT construction monitoring based on an intelligent IoT information framework according to one embodiment of the present invention;

FIG. 18 is a diagram illustrating a configuration of an intelligent virtual reality (VR) cache service based on an intelligent IoT information framework according to one embodiment of the present invention; and

FIG. 19 illustrates utilization of the intelligent VR cache service based on an intelligent IoT information framework according to one embodiment of the present invention.

FIG. 20 is a view illustrating an example of a computer system in which a method according to an embodiment of the present invention is performed.

### DETAILED DESCRIPTION OF EXEMPLARY EMBODIMENTS

Advantages and features of the present invention and methods of achieving the same will be apparent by referring to embodiments described below in detail with reference to the accompanying drawings.

However, the present invention is not limited to the embodiments described below and various modifications may be made thereto. The embodiments are merely provided to thoroughly disclose the invention and to convey the category of the invention to one of ordinary skill in the art. The present invention is defined by the appended claims.

The terminology used herein is for the purpose of describing particular embodiments only and is not intended to limit the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The background of the present invention will be described in order to assist those of ordinary skill in the art in gaining a comprehensive understanding of the present invention described herein and embodiments of the present invention will be described below.

According to the related art, an Internet of things (IoT) has a constrained environment due to a device itself and an environment of a network.

The restricted environment of the devices (things) refers to an environment in which a central processing unit (CPU) performance and memory capacity are constrained.

In the case of a network, the environment includes a constrained environment of wireless networking technology including a low power wide area (LPWA) network or a low-power and lossy network (LLN).

According to the related art, in order to provide connectivity in such an IoT environment, transmission control protocol (TCP)/Internet protocol (IP) or user datagram protocol (UDP)/IP stacks may be mounted to provide networking and a data transmission service.

In addition, IPv6 is used instead of IPv4, which is an existing Internet protocol, in order to assign IP addresses to many IoT devices.

Also, a convergence layer between an IPv6 layer and a media access control (MAC) layer has been newly developed and standardized to incorporate a new wireless technology including an LPWA network.

Further, for an application layer, a technology including a Constrained Application Protocol (CoAP), which is a lightweight alternative of the Hypertext Transfer Protocol (HTTP), is provided.

In the future, introduction of various IoT devices will increase and enormous data will be generated through these terminals.

In order to process such a large amount of data, scalable and effective networking and computing platform technologies are required.

According to such needs, edge/fog computing technology for processing data near users and IoT devices is popularized.

Mobile edge computing (MEC) technology for mobile communication is applied to the case of edge computing.

In this technology, a device, an access gateway, a base station, and the like directly perform functions required for services.

Fog computing is a distributed computing platform that is positioned between an IoT device and a central cloud computing architecture provided over the Internet.

Edge computing and fog computing are often used together and hereinafter, edge computing and fog computing technologies are described together.

Together with these various edge/fog computing technologies, in a situation where many existing IoT platforms of various existing IoT service fields coexist, development for continuously integrating the IoT platforms and supporting inter-workability is ongoing.

For example, many IoT services, such as a smart city, a smart factory, smart health care, and the like, are each being developed on the basis of a separate IoT platform.

As a result, a large number of IoT platforms have been introduced, and since such IoT platforms do not share one common technology, the cost of development and maintenance is predicted to continuously increase.

In particular, IoT devices have been developed to operate with a gateway or an actuator and hence have a shortcoming of being fixed together with specific company products like a dedicated service.

There are activities to support integration of IoT platforms through international standardization, and platforms, such as oneM2M and IoTivity of OCF, are being developed, but there is still no integrated IoT platform.

In conclusion, there are limitations in that it is impossible to process numerous IoT terminals and data only with IPv6 and CoAP, which are Internet protocol (IP) technologies like the Internet, and a central cloud server technology, and it is impossible to support scalable connectivity.

In addition, existing IoT platforms have been developed specifically for different technologies and service domains, and it is difficult to develop a solution to integrate them.

Therefore, there is a need for a technology that supports effective connectivity and mobility in resource-constrained environments of many IoT devices and networking-constrained environment and collects and processes a large amount of data generated by these devices through distributed architecture.

In addition, for compatibility with technologies, such as existing IoT platforms or a cloud server, an integrated framework is required which is applicable to various service domains and provides networking and security functions through a simple message scheme, such as RESTful, used in an application service such as the web.

In particular, in the field of smart construction, under the lead of the government, a number of construction companies have formed an alliance to jointly develop IoT and smart home technology.

Smart home-related companies, such as MDS technology, Sanyoung S&C, Wisenut, Korea Land and Housing Cooperation (LH), Seoul Housing Cooperation (SH), and the like, as well as telecommunication companies, such as SKT and KT, including electronics companies, such as Samsung Electronics, LG Electronics, Coway, Cuchen, and the like, are participating.

They are collaborating on interoperability and linkage between smart home platforms in the future and participating in public information utilization and smart home business model development.

On such a basis, the development of technologies for smart construction is also continuously in progress.

A system that manages the entire process in real time is constructed by introducing IoT to various construction sites, such as housing, architecture, civil engineering, plants, and the like, and utilizing mobile/wearable devices, drones (unmanned flight device), and the like.

A service related to smart construction is provided by fusing mutual technologies between Internet service providers and construction companies and technology and services for providing air quality information of construction sites in real time are provided.

A preventive technology is presented regarding various complaints of nearby residents in a construction site.

Existing edge computing is characterized in that delay is reduced by moving cloud computing to an edge of a network, and unnecessary traffic sent to cloud is reduced and security is enhanced.

However, in order to satisfy various service requirements of each service provider, a system needs to be constructed by separately receiving technical consulting and there is a problem in that machine learning methods are sporadically applied to each service.

The present invention has been made in order to overcome the above-described shortcomings and proposes an autonomous configured IoT information framework and information intelligence network control system for IoT service.

In addition, the present invention provides a modularized intelligent IoT framework for various applications and has a technical feature in that intelligent traffic analysis and prediction is performed.

According to one embodiment of the present invention, it is possible to provide 1) an intelligent IoT information framework, 2) edge node-based time series data prediction and determination, and 3) a variety of services based on such technologies (e.g., a smart construction monitoring system considering recyclability of edge technology).

The intelligent IoT information framework according to one embodiment of the present invention includes a gateway that forwards IoT device data and information processed based on data analysis to a cloud server.

According to one embodiment of the present invention, a structure, procedures, a configuration, and operations of intelligent Internet of everything (IoE) edge computing are proposed.

According to one embodiment of the present invention, it is possible to reduce network usage by collecting information from various sensors through an intelligent IoT information framework device and selecting a video delivery quality of a network camera which monitors a site after analyzing a situation of the site through statistical analysis and machine learning.

A construction site may be applied as an example, wherein noise, vibration, and gas information are monitored, and when such information reaches a reference value, a service for transmitting a high-definition image is provided and, as a security system, a high-definition image is transmitted after detecting an intruder using a motion detection sensor, a human detection sensor, or the like.

According to one embodiment of the present invention, operation is possible by only installing an IoT gateway without installing an additional protocol stack or an application program in a sensor.

In addition, it is possible to improve security compared to a cloud-based IoT service according to the related art, to reduce server maintenance cost, and to interwork with various cloud services.

An intelligent IoE information framework including functions of managing and controlling a distributed edge/fog intelligent networking platform on the basis of an information centric networking-based edge/fog intelligent networking platform that provides scalability, mobility, and low-latency connectivity to 10¹⁰ or more devices (Things) is proposed.

It is possible to collect, store, and process information generated by devices (Things) on the basis of an edge/fog intelligent networking platform and to control the devices or transmit a result of analysis to a cloud service.

According to the present invention, connectivity with the device is directly supported through a device networking section.

In order to support the connectivity of devices with various forms and environments, networking architecture in the form of edge/fog computing is proposed for supporting scalability, low latency, mobility, and the like.

Components for machine learning and reinforcement learning are mounted for intelligent processing of collected data so that a low-latency and time-critical IoE service may be supported.

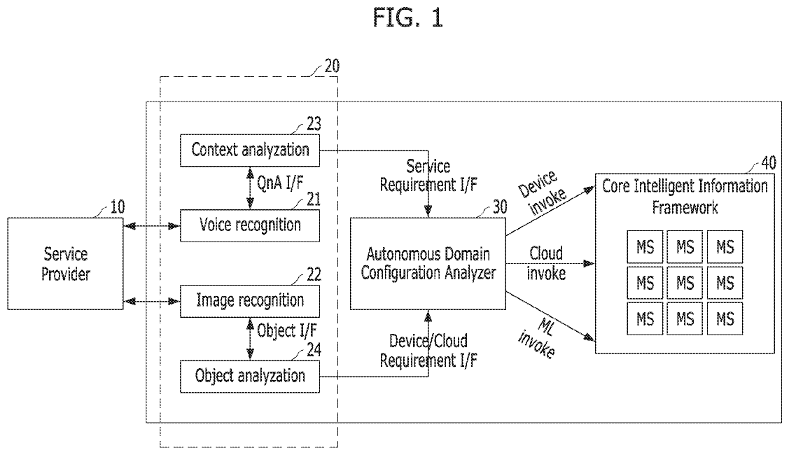

FIG. 1 is a diagram illustrating a configuration of an autonomous configurable intelligent IoT information framework according to one embodiment of the present invention. The intelligent IoT information framework according to one embodiment of the present invention is an intelligent data processing device that autonomously provides an artificial intelligence (AI) service and performs edge analytics through big data analytics.

In order to support edge analytics, data utilization through intelligent data processing including data collection, dynamic storage, and real-time data trust processing should be increased. In particular, analysis models should be updated periodically.

Technical features of the autonomous configurable intelligent IoT information framework according to one embodiment of the present invention include a micro service-based reconfiguration, a question-and-answer (QnA)/object interface (I/F), a voice and image recognition-based edge computing configuration, and a core intelligent IoE information framework.

According to one embodiment of the present invention, when there is a specific requirement from a domain service provider, a configuration of an intelligent information framework suitable for a domain service is automatically requested through voice and image recognition.

Referring to FIG. 1, the autonomous configurable intelligent IoT information framework according to one embodiment of the present invention includes a voice/image recognition and analysis module 20, an autonomous domain configuration analyzer 30, and a core intelligent information framework 40.

The voice recognition and analysis module 20 receives a requirement of a domain provider from a service provider 10 by voice.

For example, a service requirement by voice, such as “I want to perceive an alarm,” “I want to reduce costs by reducing traffic because video traffic is congested,” or the like is received.

A voice received through a voice recognition unit 21 is forwarded to a context analyzation module 23 through the QnA object I/F and the context analyzation module 23 analyzes the domain service requirement through morphological analysis.

The analyzed service requirement is forwarded to the autonomous domain configuration analyzer 30.

In addition, the image recognition and analysis module 20 recognizes a current device and service status of the service provider 10 through an image.

For example, when an image including a “sensor,” a “cloud device,” a “management screen,” an “access device,” and the like is transmitted, an image recognition unit 22 automatically recognizes objects related to the components, such as the corresponding device.

The recognized objects are provided to an object analyzation module 24 through an object I/F.

The object analyzation module 24 analyzes device/cloud requirements such as the type and specification of an object of interest.

The analyzed device/cloud requirements are forwarded to the autonomous domain configuration analyzer 30.

The autonomous domain configuration analyzer 30 requests to the domain service providers to “configure an appropriate core intelligent information framework device” by referring to the collected service, device, and cloud requirements.

The core intelligent information framework 40 is configured in the form of various micro services and is reconfigurable.

The autonomous domain configuration analyzer 30 invokes an appropriate micro service according to the requirement and operates as an autonomous configurable intelligent IoT information framework.

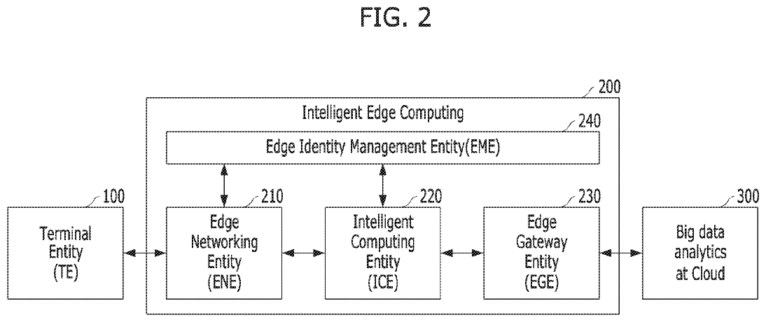

Hereinafter, a configuration of the core intelligent information framework 40 will be described with reference to FIG. 2.

FIG. 2 is a block diagram illustrating an intelligent IoT edge computing system according to one embodiment of the present invention.

According to one embodiment of the present invention, an edge networking entity (ENE) 210, an intelligent computing entity (ICE) 220, an edge gateway entity (EGE) 230, and an edge identify management entity (EME) 240 are included.

Basically, the intelligent edge computing system 200 is deployed in a location between a terminal entity (TE) and a big data analytics server 300 which performs big data analytics on cloud computing.

The ENE 210 provides connectivity to the TE 100 using heterogeneous wireless technologies in a resource constrained environment.

Thus, the ENE 210 is deployed for various wireless technologies as well as protocols between the TE 100 and the intelligent edge computing system 200.

The ICE 220 provides an edge analytics function of an AI service on itself or other analytics functions, such as big data analytics on cloud computing.

The ICE 220 performs data analysis functions through gathering information and controls the TE 100 through the result of the analytics in addition to the edge analytics.

When an abnormal situation or some events have been predicted according to edge analysis of collecting data, the ICE 220 sends a request message related to a type of action defined by a service profile.

The EGE 230 provides an interworking function to outside entities including other intelligent edge computing (IEC) systems and a big data analytics function on cloud computing.

The EME 240 stores/manages a kind of identity (ID) of all entities, such as the TE 100, the ENE 210, the ICE 220, and the EGE 230, including data names as an ID.

The EME 240 maps these identities to metadata such as a location of the intelligent edge computing system 200 and a location of the EGE 230.

Thus, the EME 240 performs mobility management such as mobility of the TE 100.

According to one embodiment of the present invention, an intelligent information processing manager (orchestrator), a data storage unit (database), a reward, and an action unit are included.

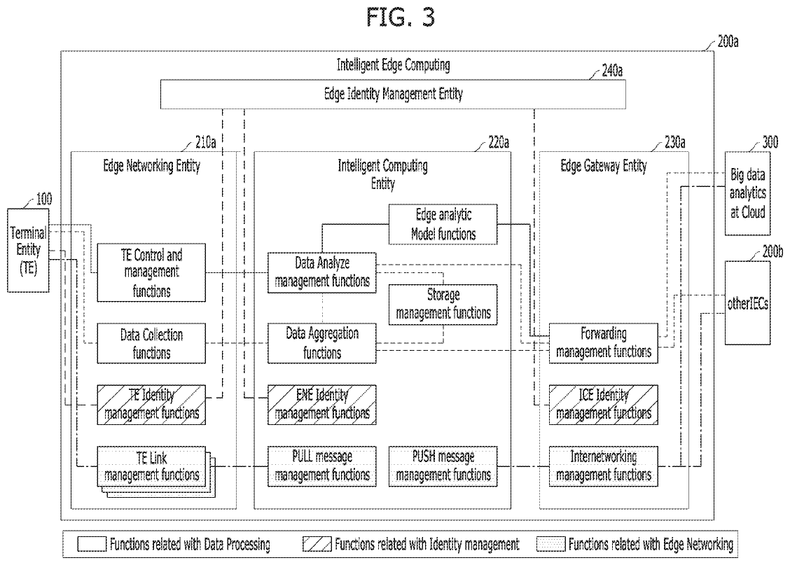

FIG. 3 is a diagram illustrating a functional configuration of an intelligent IoT edge computing system according to one embodiment of the present invention.

Referring to FIG. 3, various functional blocks are included in each of an ENE 210a, an ICE 220a, and an EGE 230a.

A TE control and management function and a data collection function of the ENE 210a, a data analyze function, an edge analytic model function, a storage management function, and a data aggregation function of the ICE 220a, and a forwarding management function of the EGE 230a are functions related to data processing.

A TE ID management function of the ENE 210a, an ENE ID management function of the ICE 220a, and an IEC ID management function of the EGE 230a are functions related to ID management.

A TE link management function of the ENE 210a, a pull message management function and a push message management function of the ICE 220a, and an Internet working management function of the EGE 230a are functions related to edge networking.

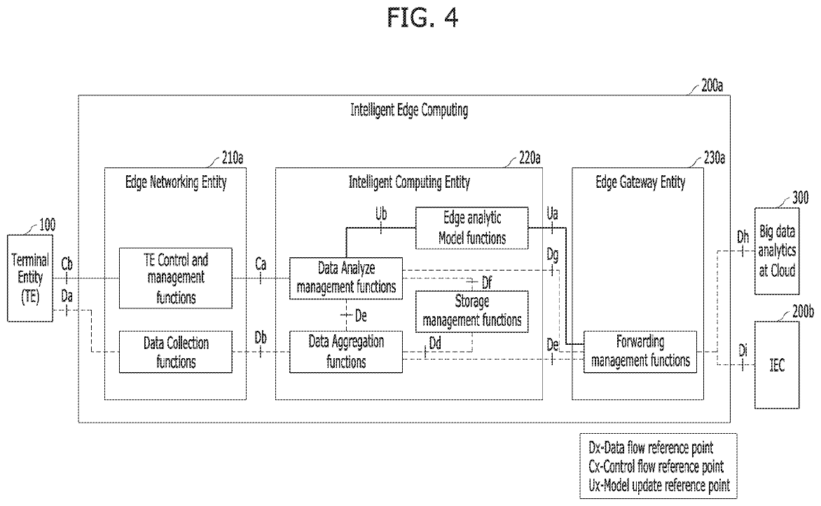

FIG. 4 is a diagram illustrating reference points of an intelligent IoT edge computing system according to one embodiment of the present invention.

Reference points are largely classified into three types, Dx, Cx, and Ux.

A Reference point Dx denotes a reference point for a data flow and includes reference points Da, Db, Dc, Dd, De, Df, and Dg.

Da denotes an interface between the TEl 00 and the data collection functions of the ENE 210a to collect raw data.

Db denotes an interface between the data collection functions of the ENE 210a and the data aggregation functions of the ICE 220a.

Dc denotes an interface between the data aggregation functions of the ICE 220a and the forwarding management functions of the EGE 230a.

Dd denotes an interface between the data aggregation functions of the ICE 220a and the storage management functions of the ICE 220a.

De denotes an interface between the data aggregation functions and the data analyzing functions of the ICE 220a.

Df denotes an interface between the data analyzing functions and the storage management functions of the ICE 220a.

Dg denotes an interface between the data analyzing functions of the ICE 220a and the forwarding management functions of the EGE 230a.

Dh denotes an interface between the forwarding management functions of the EGE 230a and the big data analytics server 300 on cloud, and Di denotes an interface between the forwarding management functions of the EGE 230a and other IECs 200b.

Reference point Cx is a reference point for a control flow and includes reference points Ca and Cb.

Ca denotes an interface between the TE control and management functions of the ENE 210a and the data analyzing functions of the ICE 220a.

Cb denotes an interface between the TE control and management functions of the ENE 210a and the TE 100.

Reference point Ux is a reference point for a model update and includes reference points Ua and Ub.

Ua denotes an interface between the edge analytic model functions of the ICE 220a and the forwarding management functions of the EGE 230a.

Ub denotes an interface between the data analyzing functions and the edge analytic model function of the ICE 220a.

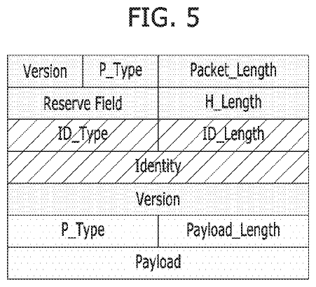

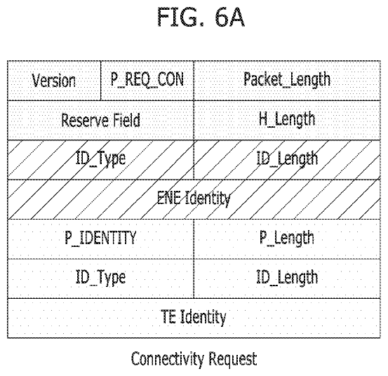

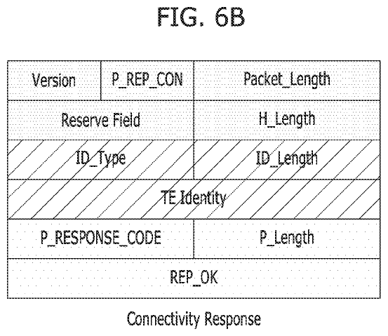

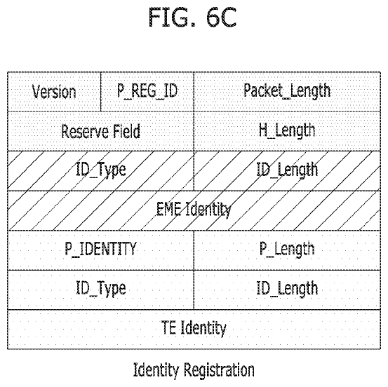

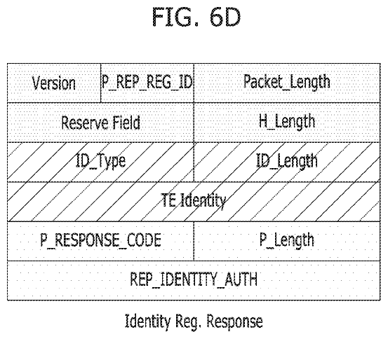

FIG. 5 illustrates a message format of a reference point according to one embodiment of the present invention, and FIG. 6A through FIG. 6D are diagrams illustrating message specifications of a reference point according to one embodiment of the present invention.

A message is used in the Type-Length-Value (TVL) encoding format, and Type and Length fields are encoded in 2 bytes.

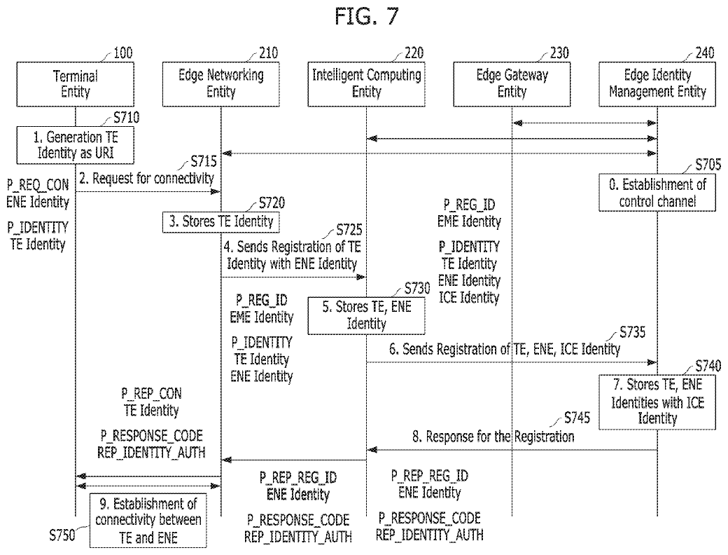

FIG. 7 is a flowchart illustrating autonomous initialization processing according to one embodiment of the present invention.

An ENE 210, an ICE 220, and an EGE 230, which are IEC entities, are connected to an EME 240 as a control channel (S705).

A TE 100 generates an ID using a hierarchical name in the same layer as a uniform resource identifier (URI) type (S710).

The TE 100 sends a request for connectivity to the ENE 210 (S715).

The ENE 210 stores the ID of the TE 100 in a table (S720).

The ENE 210 sends a registration message to the ICE 220 to notify the ICE 220 of the ID of the TE 100 and sends the ID of the ENE 210 to the ICE 220 (S725).

The ICE 220 stores the identities of the TE 100 and the ENE 210 (S730).

The ICE 220 sends a registration request for the identities of the TE 100, the ENE 210, and the ICE 220 (S735).

The EME 240 maps the identities of the TE 100, the ENE 210, and the ICE 220 and stores the mapped identities (S740) and sends a response message for the registration request to the TE 100 (S745).

Through these procedures, connection between the TE 100 and the ENE 210 is established (S750).

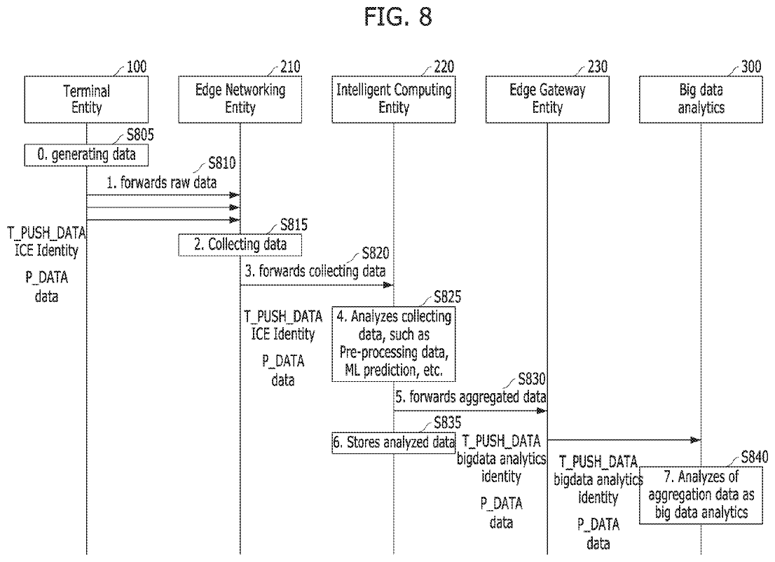

FIG. 8 is a flowchart illustrating intelligent data processing according to one embodiment of the present invention.

A TE 100 generates raw data (or single unit data) via some triggering event (S805).

The TE 100 forwards the raw data to an ENE 210 (S810).

In this case, partitioned raw data is collected by the ENE 210 via connectivity between the TE 100 and the ENE 210 (S815).

The ENE 210 collects partitioned data.

The ENE 210 forwards the collected data to an ICE 220 (S820).

The ICE 220 analyzes aggregation data (S825) and forwards a result of the analysis to an EGE 230 (S830).

The aggregation data may either be stored in a storage or analyzed directly as stream data processing.

The aggregation data is first processed as pre-processing phases such as data quality (DQ) and extract, transform, and load.

In addition, normalized data is processed using an AI model.

For instance, in order to predict a future event, a machine learning (ML) prediction model may be applied to the edge analytics.

As a result of edge analytics, the ICE 220 forwards the analyzed data to a big data analytics server 300.

In this case, according to the result of ML prediction, forwarding data is controlled to reduce traffic load between the ICE 220 and the big data analytics server 300 by a kind of video quality adaptation function such as a video transcoding function.

The edge analyzed data is stored via the storage function of the ICE 220 (S835).

Big data analysis of edge analyzed data may be found as new features, such as an AI model update (S840).

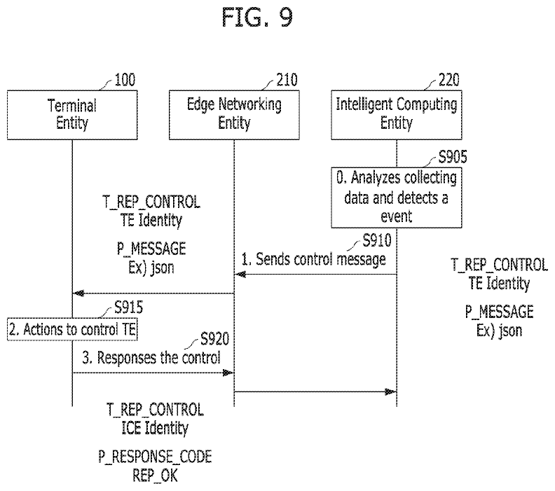

FIG. 9 is a flowchart illustrating intelligent data processing for terminal control according to one embodiment of the present invention.

According to edge analysis of collecting data, an abnormal situation or some events are predicted (S905).

An ICE 220 sends a request message to command an action (S910).

In this case, types of actions may be defined by a service profile.

For instance, in a video surveillance system, the ICE 220 may directly control a surveillance camera.

The TE 100 takes an immediate action (S915). For example, a camera may encode a high-quality video in prediction time directly.

The TE 100 sends a response to the request to the ICE 220 (S920).

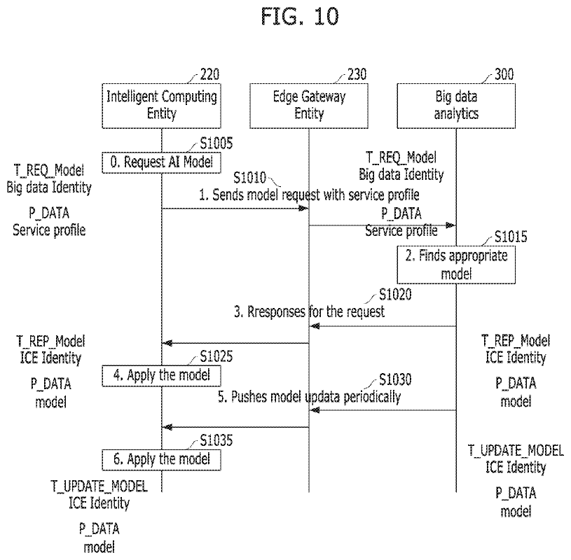

FIG. 10 is a flowchart illustrating ML model update processing according to one embodiment of the present invention.

Before achieving edge analytics, an ICE 220 requests an AI model from big data analytics on a cloud server or a model repository (S1005).

The ICE 220 sends a request message for an AI model with a service profile (S1010).

According to a check of the service profile, an appropriate AI model is established at a big data analytics server 300 or model repository (S1015).

The big data analytics server 300 sends a response to a request (S1020), wherein the request is for attaching the AI model and parameters.

The model is applied to the ICE 220 to proceed to an edge analytics (S1025).

After a reasonable period of time, the big data analytics server 300 pushes to update the model (S1030).

The ICE 220 may request a new AI model explicitly.

The ICE 220 applies the model (S1035).

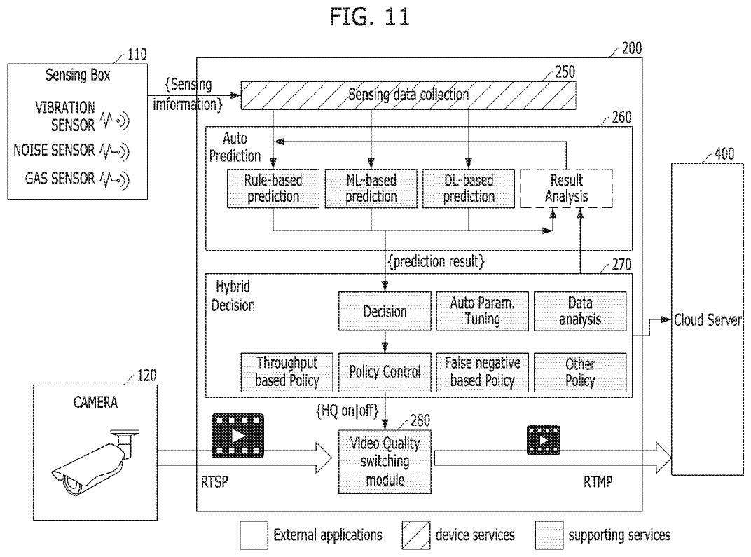

FIG. 11 is a diagram illustrating a configuration for edge node-based time series data prediction and decision according to one embodiment of the present invention.

The edge node-based time series data prediction and decision configuration according to one embodiment of the present invention is characterized in terms of 1) rule-based, ML-based, and DL-based fusion prediction, 2) hybrid prediction and decision algorithm, and 3) policy-based traffic control, traffic minimization, cost minimization (flat rate pricing and usage-based pricing), and satisfaction on service quality.

Referring to FIG. 11, the configuration for the edge node-based time series data prediction and decision according to one embodiment of the present invention includes a sensing box 110, a camera 120, an edge computing system 200, and a cloud server 400.

The sensing box 110 is a set of a plurality of sensors such as a vibration sensor, a noise sensor, a gas sensor, and the like.

The sensing box 110 provides information of various sensors, such as noise, vibration, gas, and the like, to the edge computing system 200.

The camera 120 may photograph a full high-definition (FHD) quality image of a construction site in real time and provide the image to the edge computing system 200.

The edge computing system 200 provides connectivity to be provided with data from a things network, as well as an IoE information processing function.

In addition, the edge computing system 200 operates as a networking platform between constituent nodes and components in each framework.

In addition, the edge computing system 200 operates as a platform that provides networking with a cloud server on the Internet.

The edge computing system 200 includes a sensing data collection unit 250, a prediction unit (static prediction, ML-based prediction) 260, a decision unit 270, and a video quality adaptation unit 280.

The cloud server 400 receives sensor information via Amazon web-service (AWS) IoT or receives video information via a real time message protocol (RTMP).

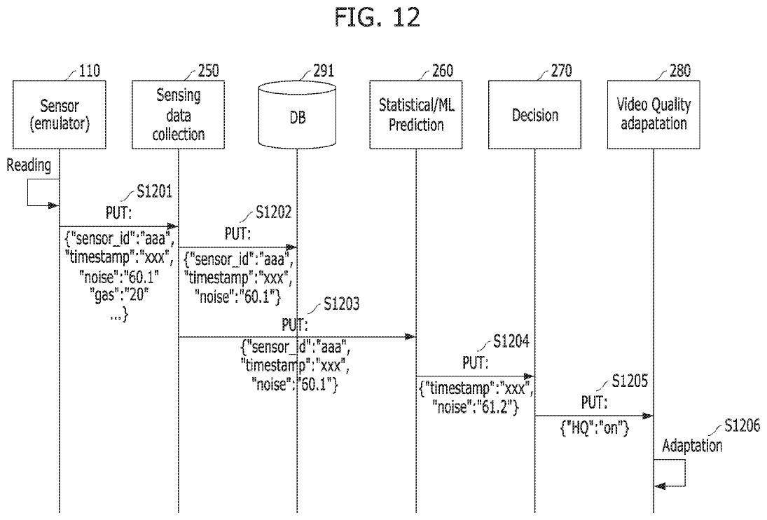

FIG. 12 is a diagram illustrating procedures for edge node-based time series data prediction and decision according to one embodiment of the present invention.

According to one embodiment of the present invention, through the procedures shown in FIG. 12, raw data or single unit data generated from a sensor 110 is processed.

Data received through the sensor 110 is stored in a database (DB) 291 through a sensing data collection unit 250 (S1201 and S1202).

In addition, the data is sent from the sensing data collection unit 250 to the prediction unit 260 (S1203).

The prediction unit 260 predicts data of the next period on the basis of the collected data and forwards the predicted data to the decision unit 270 (S1204).

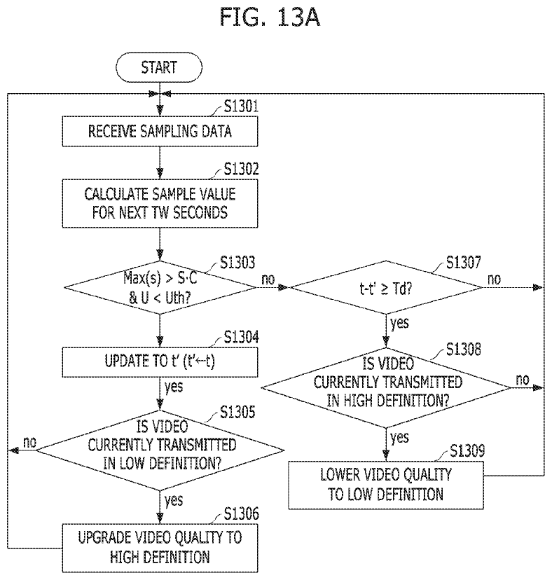

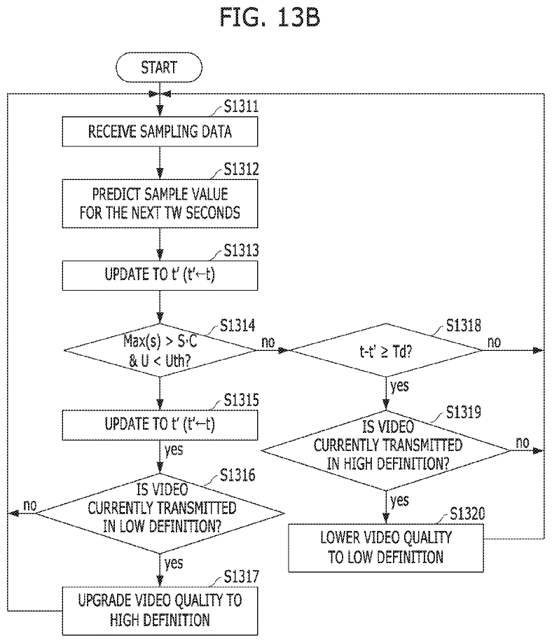

The decision unit 270 determines whether video data is to be sent in high definition or low definition according to an algorithm of FIG. 13A and FIG. 13B, which will be described below, and forwards the determination result to the video quality adaptation unit 280 (S1205).

The video quality adaptation unit 280 applies video quality according to the result received from the decision unit 270 (S1206) and transmits the video data to the cloud server.

A prediction algorithm for a decision is as follows and according to one embodiment of the present invention, an optimal algorithm is selected from among a plurality of algorithms.

A rule-based algorithm includes a last value (LV) algorithm and a moving average (MA) algorithm.

An ML-based algorithm includes multi variable regression prediction (MV_RP).

A deep learning-based algorithm includes MV_RP, long short term memory (LSTM), and a general recurrent unit (GRU).

FIGS. 13A and 13B illustrate decision algorithms according to one embodiment of the present invention, and parameters of each algorithm are automatically selected.

The algorithm of FIG. 13A is based on a static alarm-based data transmission control scheme (SA-DCS), and the algorithm of FIG. 13B is based on a dynamic alarm-based data transmission control scheme (DA-DCS).

As parameters of FIGS. 13A and 13B, S denotes noise limit (dB), C denotes image quality change sensitivity (0<C<1), Ns denotes the number of samplings per second, Tw denotes noise prediction window size (second), Td denotes image quality reduction reference time (second), Uth denotes a network usage limit threshold (Kbps), and FNth denotes a false negative number limit threshold (number of instances).

Referring to FIG. 13A, sampling data is received (S1301), and noise levels (s₁, s₂, . . . , s_{Tw}*_{Ns}) for the next Tw seconds are calculated (S1302).

It is checked whether a result of calculating the noise levels is greater than computation results of noise limit and image quality change sensitivity and the network usage until present time is smaller than the network usage limit threshold (S1303).

When “YES” in operation S1303, current time t is updated to the last time point at which t′(Max(sᵢ)>S*C (S1304), and it is checked whether a video is currently transmitted in low definition (S1305).

When “YES” in operation S1305, video quality is upgraded to high definition (S1306), and when “NO” in operation S1305, the process returns to operation S1301.

When “NO” in operation S1303, it is checked whether a difference between the last time point at which t′(Max(sᵢ)>S*C and the current time t is greater than or equal to the image quality reduction reference time (S1307).

When “NO” in operation S1307, the process returns to operation s1301, and when “YES” in operation 1307, it is checked whether the video is currently transmitted in high definition (S1308).

When “NO” in operation S1308, the process returns to operation S1301, and when “YES” in operation S1308, the video quality is lowered to low definition (S1309).

Referring to FIG. 13B, sampling data is received (S1311), and noise levels (s₁, s₂, . . . , s_{Tw}*_{Ns}) for the next Tw seconds are predicted (S1312).

Then, the image quality change sensitivity is adjusted (S1313).

Then, it is checked whether a noise level prediction value is greater than computation results of noise limit and image quality change sensitivity and network usage until present time is smaller than a network usage limit threshold (S1314).

When “YES” in operation S1314, the current time t is updated to the last time point at which t′(Max(sᵢ)>S*C (S1315), and it is checked whether the video is currently transmitted in low definition (S1316).

When “YES” in operation S1316, the video quality is upgraded to high definition (S1317) and when “NO” in operation S1306, the process returns to operation S1311.

When “NO” in operation S1314, a difference between the last time point at which t′(Max(sᵢ)>S*C and the current time t is greater than or equal to the image quality reduction reference time (S1318).

When “NO” in operation S1318, the process returns to operation S1311, and when “YES” in operation S1318, it is checked whether the video is currently transmitted in high definition (S1319).

When “NO” in operation S1319, the process returns to operation S1311, and when “YES” in operation S1319, the video quality is lowered to low definition (S1320).

According to the above-described algorithm, for example, in a case where S=60 dB, C=0.8, Tw=30 sec, and Td=10 sec, when a point where a noise level exceeding 48 dB is predicted in the next 30 seconds, transmission of video in high definition for 10 seconds is ensured.

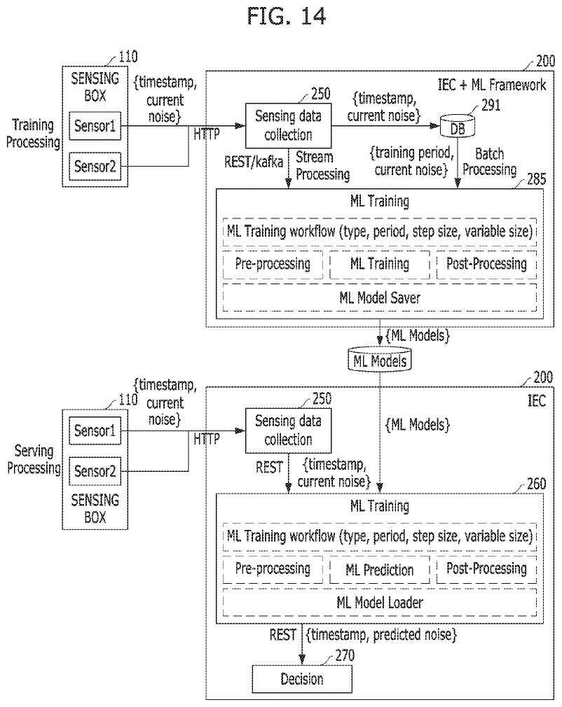

FIG. 14 is a diagram illustrating a configuration of training and serving for edge node-based time series data prediction and decision according to one embodiment of the present invention.

Referring to FIG. 14, in a training process, pieces of sensor information in a sensing box 110 are forwarded to an intelligent edge computing system 200.

A training processing method of a sensing data collection unit 150 is divided into a streaming processing method and a batch processing method.

In the streaming processing method, collected data is forwarded to an ML training processing module 285 to be learned, and a learning result is stored in an ML model DB 292.

In the batch processing method, the sensing data collection unit 250 stores sensing data in a DB 291 and after data is consistently collected, the collected data is processed as a whole in the ML training processing module 285, and a learning result is stored in the ML model DB 292. Pieces of sensor information in the sensing box 110 are forwarded to the intelligent edge computing system 200.

The sensing data collection unit 250 sends the sensing data to a prediction unit 260.

The prediction unit 260 retrieves the latest learning result from the ML model DB 292, predicts a future value, and forwards a prediction result to a decision unit 270.

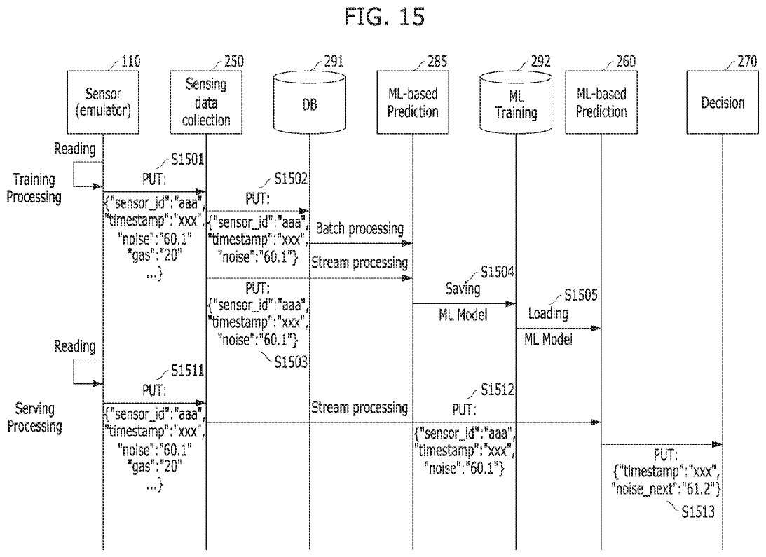

FIG. 15 is a flowchart illustrating training and serving for edge node-based time series data prediction and decision according to one embodiment of the present invention.

In a training processing process, a sensor 110 sends a PUT message to a sensing data collection unit 250 in a Representational State Transfer (REST) manner (S1501).

The sensing data collection unit 250 stores corresponding data in a DB 291 (S1502) and, at the same time, sends a PUT message to an ML training processing module 285 in a REST manner (S1503).

Examples of a message format of each PUT message to be sent include sensor_id, timestamp, noise, gas, and the like.

The ML training processing module 285 performs learning based on the corresponding data and stores a learning result in an ML model DB 292 (S1504).

The prediction unit 260 loads the most recently stored ML model for serving (S1505).

In a serving processing process, the sensor 110 forwards sensing data to the sensing data collection unit 250 (S1511).

The sensing data collection unit 250 forwards a REST PUT message to the prediction unit 260 (S1512).

The prediction unit 260 predicts a result of the next step and sends corresponding data to a decision unit 270 (S1513).

Hereinafter, a domain service based on an intelligent IoE information framework according to one embodiment of the present invention will be described.

According to one embodiment of the present invention, it is possible to provide various services on the basis of the above-described autonomous configurable intelligent IoT information framework and edge node-based time series data prediction and decision technologies.

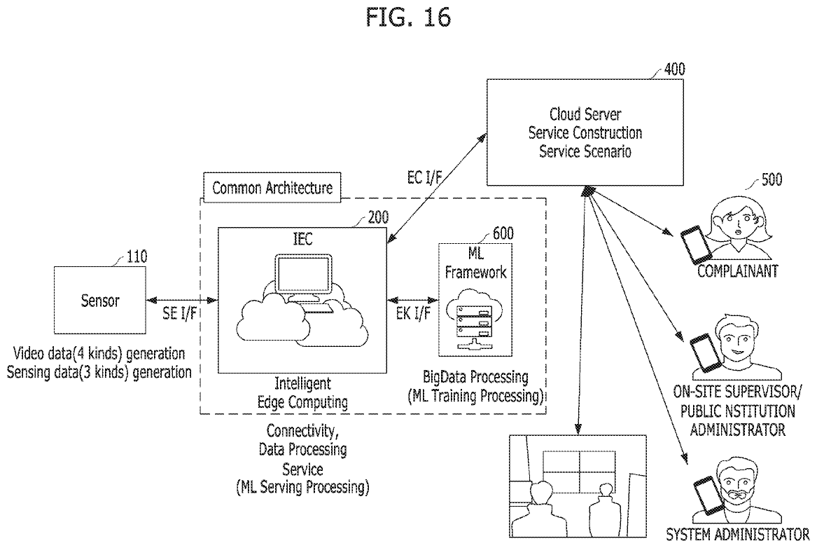

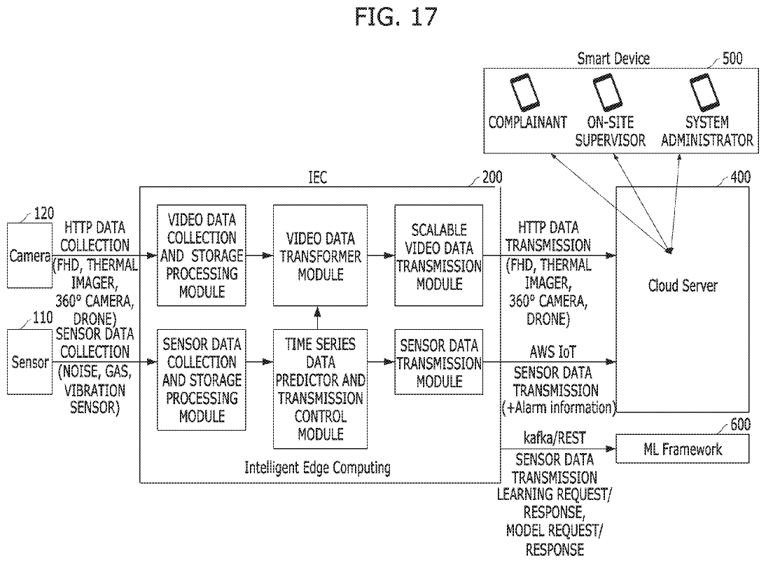

FIGS. 16 and 17 are diagrams illustrating a configuration of smart IoT construction monitoring based on an intelligent IoT information framework according to one embodiment of the present invention.

Referring to FIG. 16, intelligent IoT information framework-based smart IoT construction monitoring is illustrated.

An intelligent edge computing system 200 and an ML framework system 600 are provided as common architectures, and a sensing box 110 is located at the west and is interlocked with a cloud server 400 at the east.

Devices 500 of a complainant, an on-site supervisor, and a system manager use services through cloud.

Referring to FIG. 17, the intelligent edge computing system 200 includes an input/output interface processing module (HTTP, AWS IoT, etc.), a data collection and storage processor of a sensor 110 or a camera 120, a time series data analysis and predictor (prediction of an alarm of TS sensor data), an video data transformer controller (FHD, HD, standard definition(SD) transformer REST API), a sensor data transmission module (REST API and transmission of sensor data in conformity with AWS IoT transmission scheme), and a scalable video data transmission module (REST API and transmission of scalable data for an alarm section and a non-alarm section).

According to one embodiment of the present invention, the smart IoT construction monitoring is realized by utilizing open source-based edging computing (e.g., EdgeX).

According to one embodiment of the present invention, from the viewpoint of data flow, it is possible to efficiently transmit and store construction site data (noise, vibration, gas, and image) and thereby reduce traffic of a wireless communication section.

From the viewpoint of a user, it is possible to check information (noise, vibration, gas, and image) in real time through searching by location and by time when there are requests from a complainant, an on-site supervisor, and a local government manager.

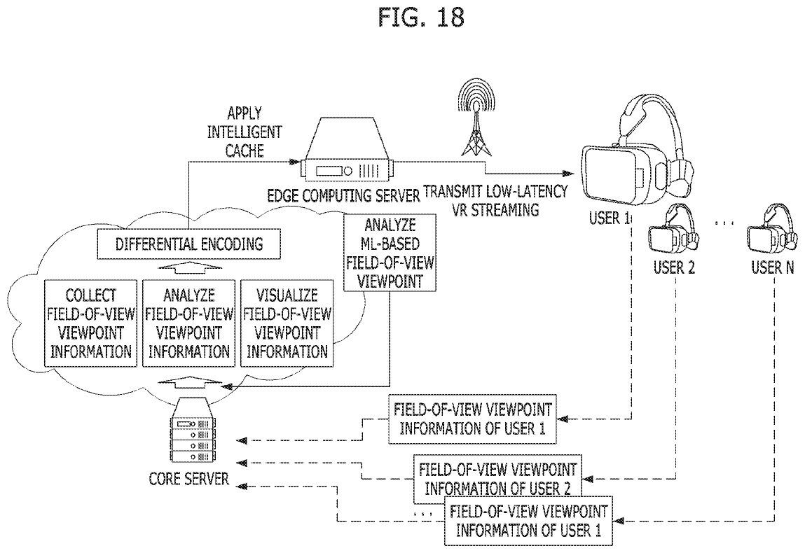

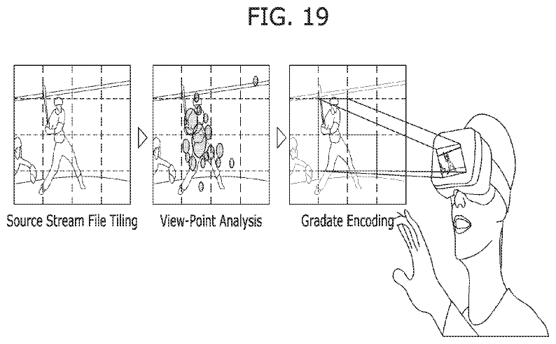

FIG. 18 is a diagram illustrating a configuration of an intelligent virtual reality (VR) cache service based on an intelligent IoT information framework according to one embodiment of the present invention, and FIG. 19 illustrates utilization of the intelligent VR cache service based on an intelligent IoT information framework according to one embodiment of the present invention.

Viewpoint information may be collected on a statistical basis and is analyzed on the basis of ML.

Ultimately, a user should determine a spatial viewpoint.

A differential encoder differentially performs encoding in three levels: high, middle, and low.

A user may receive low-latency VR streaming from an edge computing server and it is possible to receive data at an earlier time compared to the conventional technologies.

According to one embodiment of the present invention, it is possible to control a video traffic control policy for cost reduction and control traffic sharing for high reliability on the basis of the intelligent IoT information framework.

In addition, it is possible to provide a smart vehicle self-driving service including mobility control and quality of service (QoS) control, a valuable transmission control service for providing a seamless video service, and a personal broadcasting uplink service allowing for uplink traffic control optimized for grades of multiple users.

According to the present invention, an autonomous configurable intelligent information framework and a time series-based prediction and decision technologies are proposed so that it is possible to expand to various services based on an intelligent information framework.

According to one embodiment of the present invention, it is possible to provide an intelligent IoT field live monitoring service that quickly synchronizes on-site noise, vibration, and gas values and a construction field image and provides the image online in the event of a complaint.

In addition, it is possible to prevent overflow and efficiently store a field image in cloud.

According to the present invention, a traditional passive monitoring method may be allowed to switch to an active and immediate collaboration service and it is possible to utilize collected data as basic data for ML.

Advantageous effects of the invention are not limited to the aforementioned effects, and other advantageous effects that are not described herein should be clearly understood by those skilled in the art from the above detailed description.

Meanwhile, the intelligent IoE edge computing method according to one embodiment of the present invention may be embodied in a computer system or recorded on a computer-readable storage medium. The computer system may include at least one processor, a memory, a user input device, a data communication bus, a user output device, and a repository. Each of the above-described components performs data communication through the data communication bus.

The computer system may further include a network-coupled network interface. The processor may be a CPU or a semiconductor device that processes a command stored in the memory and/or the repository.

The memory and the repository may include various forms of volatile or non-volatile storage medium. For example, the memory may include a read-only memory (ROM) and a random access memory (RAM).

Therefore, the intelligent IoE edge computing method according to one embodiment of the present invention may be embodied as a computer executable method. When the intelligent IoE edge computing method according to one embodiment of the present invention is performed in the computing device, computer-readable commands may perform the intelligent IoE edge computing method according to the present invention.

In the meantime, the above-described intelligent IoE edge computing method according to the present invention may be embodied as computer-readable code on a computer-readable recording medium. The computer readable recording medium is any data storage device that can store data which is readable by a computer system. For example, the computer readable recording medium may be a ROM, a RAM, a magnetic tape, a magnetic disk, flash memory, an optical data storage device, or the like. In addition, the computer-readable recording medium may be distributed among computer systems connected via a communication network and stored in the form of a code that can be read and executed by a de-centralized method.

While the present invention has been particularly shown and described with reference to the embodiments thereof, it will be understood by those skilled in the art that various changes in form and details may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present invention.

The present invention described above may be embodied as computer-readable code on a program recording medium. The computer-readable medium includes all types of storage devices configured to store data that can be read by a computer system. Examples of the computer-readable medium include a hard disk drive (HDD), a solid-state drive (SSD), a silicon disk drive (SDD), a read-only memory (ROM), a random-access memory (RAM), a compact disc (CD)-ROM, a magnetic tape, a floppy disk, an optical data storage device, and the like. In addition, the computer-readable medium may be implemented in the form of a carrier wave (e.g., transmission through the Internet).

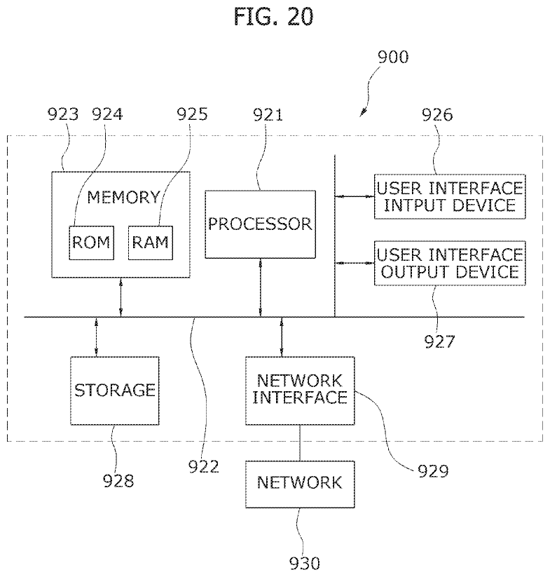

The method according to an embodiment of the present invention may be implemented in a computer system or may be recorded in a recording medium. FIG. 20 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

Further, the above description is to be considered illustrative rather than restrictive in all aspects. The scope of the invention is to be interpreted in a sense defined by the appended claims, and the present invention covers all modifications provided they come within the scope of the appended claims and their equivalents.

What is claimed is:

1. An intelligent Internet of everything (IoE) edge computing system comprising:
an edge networking entity configured to provide connectivity to a terminal entity;
an intelligent computing entity configured to provide an edge analytics function;
an edge gateway entity configured to perform interworking with outside entities; and
an edge identity management entity that stores and manages an identity.

2. The intelligent IoE edge computing system of claim 1, wherein the edge networking entity provides the connectivity to the terminal entity by taking into consideration heterogeneous wireless technologies.

3. The intelligent IoE edge computing system of claim 1, wherein the intelligent computing entity provides the edge analytics function provided by an artificial intelligence (AI) service and a big data analytics function.

4. The intelligent IoE edge computing system of claim 1, wherein the edge gateway entity provides an interworking function to outside entities including other intelligent edge computing (IEC) systems and a big data analytics function on cloud computing.

5. The intelligent IoE edge computing system of claim 1, wherein the edge identity management entity manages the identity by mapping the identity to metadata.

6. The intelligent IoE edge computing system of claim 1, wherein the edge networking entity collects raw data from the terminal entity and forwards a collection result to the intelligent computing entity, and the intelligent computing entity analyzes aggregation data and forwards analyzed data to a big data analytics server.

7. The intelligent IoE edge computing system of claim 1, wherein the intelligent computing entity sends a request message related to a type of action predefined by a service profile when an abnormal situation or some events are predicted according to edge analytics of collecting data.

8. The intelligent IoE edge computing system of claim 1, wherein the intelligent computing entity sends a request message including a service profile, performs edge analytics by applying thereto an AI model that is established according to checking of the service profile, and applies the model according to a model update pushed by a big data analytics server after a predetermined period.

9. An intelligent Internet of everything (IoE) edge computing system comprising:
a sensing data collection unit configured to collect data from a sensing box;
a prediction unit configured to predict data of a next period on the basis of the collected data; and
a decision unit configured to receive the predicted data from the prediction unit and determine quality of a video received from a camera.

10. The intelligent IoE edge computing system of claim 9, wherein the prediction unit performs autonomous prediction of minimum cost through fusion of rule-based prediction, machine learning-based prediction, and deep learning-based prediction.

11. The intelligent IoE edge computing system of claim 9, wherein the decision unit performs calculation or prediction on a sample value within a noise prediction window and determines video quality by taking into consideration noise limit, image quality change sensitivity, and whether a network usage limit threshold is exceeded.

12. An intelligent Internet of everything (IoE) edge computing system comprising:
a sensing data collection unit configured to collect data from a sensing box;
a machine learning training processing module configured to process machine learning training by using sensing data; and
a prediction unit configured to predict data of a next period on the basis of the collected data.

13. The intelligent IoE edge computing system of claim 12, wherein the sensing data collection unit forwards data to the machine learning training processing module, and the machine learning training processing module stores a learning result in a machine learning model database (DB).

14. The intelligent IoE edge computing system of claim 12, wherein the sensing data collection unit stores data in a database (DB) and the machine learning training processing module stores a learning result in a machine learning DB when learning data is processed after a predetermined amount of data is collected.

15. The intelligent IoE edge computing system of claim 12, wherein the prediction unit loads a latest learning result from a machine learning model database (DB) and forwards a prediction result to a decision unit.
